(19) United States
(12) Patent Application Publication
(10) Pub. No.: US 2022/0108358 A1
(43) Pub. Date: Apr. 7, 2022

(54) PROVIDING PERSONALIZED RECOMMENDATIONS OF GAME ITEMS

(71) Applicant: Roblox Corporation, San Mateo, CA (US)

(72) Inventors: Xusheng SUN, Sunnyvale, CA (US); Nishanth RAGHUPATHI, Santa Clara, CA (US); Nikolaus SONNTAG, Foster City, CA (US); Aman THAKUR, San Jose, CA (US); Kumar MANINDRA, Fremont, CA (US)

(73) Assignee: Roblox Corporation, San Mateo, CA (US)

(21) Appl. No.: 17/065,457

(22) Filed: Oct. 7, 2020

(51) Int. Cl. G06Q 30/02; G06N 20/20; G06F 17/16

(52) U.S. Cl. CPC G06Q 30/0282; G06F 17/16; G06N 20/20

(57) ABSTRACT

Implementations described herein relate to methods, systems, and computer-readable media to personalize recommendations. In some implementations, a method includes computing a user-based similarity matrix and a game-based similarity matrix, obtaining a set of user scores from a first machine learning model and the user-based similarity matrix, and obtaining a set of game scores from a second machine learning model and the game-based similarity matrix. The method also includes combining the set of user scores and the set of game scores to generate a normalized set of scores, identifying a set of personalized recommendations for the user associated with a subset of the normalized set of scores, assigning a rank to each of the plurality of items, generating a list of items wherein items in the list of items are ordered based on respective ranks, and providing a user interface to the user that includes the list of items.

### TECHNICAL FIELD

Embodiments relate generally to computer-based gaming, and more particularly, to methods, systems, and computer readable media to provide personalized recommendations of game items.

### BACKGROUND

Some online gaming platforms allow users to access content such as games and game assets, connect with each other, interact with each other (e.g., within a game), and share information with each other via the Internet. Users of online gaming platforms may participate in multiplayer gaming environments in which games or parts of games have been provided for interaction and/or purchase.

When users search for game-related content (e.g., games, game items, accessories for avatars, etc.) or other content, a search engine of an online gaming platform may return search results based on factors such as popularity in terms of numbers of downloads by users of the platform, rating by users platform, etc. However, such search engines may provide search results that are organized based on collective preferences or data based on a large volume of users. This can confuse and frustrate users who receive results that are not suited to their personal preferences or gaming style.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to display of personalized recommendations to a user. In some implementations, a method includes computing a user-based similarity matrix based at least in part on user data associated with a user of an online gaming platform; obtaining a set of user scores from a first machine learning model and the user-based similarity matrix, wherein the set of user scores indicates a likelihood of user engagement with a plurality of items; computing a game-based similarity matrix based at least in part on game data associated with a game played by a user within the user-based similarity matrix; obtaining a set of game scores from a second machine learning model and the game-based similarity matrix, wherein the set of game scores indicates a likelihood of user engagement with the plurality of items; combining the set of user scores and the set of game scores to generate a normalized set of scores; identifying a set of personalized recommendations for the user for each item of the plurality of items associated with a subset of the normalized set of scores; assigning a rank to each of the plurality of items based on the set of personalized recommendations; generating a list of items, wherein items in the list of items are ordered based on respective ranks; and providing a user interface to the user that includes the list of items.

Various implementations and examples of the method are described. For example, in some implementations, computing the user-based similarity matrix comprises utilizing a distance function to identify a neighborhood of users similar to the user.

In some implementations, the first machine learning model is trained to compute the set of user scores based on the user-based similarity matrix and the second machine learning model is trained to compute the set of game scores based on the game-based similarity matrix.

In some implementations, computing the game-based similarity matrix comprises utilizing a distance function to identify a neighborhood of games similar to at least one target game.

In some implementations, combining the set of user scores and the set of game scores comprises: normalizing the set of user scores to create normalized user scores; normalizing the set of game scores to create normalized game scores; adding normalized user scores to normalized game scores that overlap; and combining non-added normalized user scores, non-added normalized game scores, and the added scores to obtain the normalized set of scores.

In some implementations, identifying the set of personalized recommendations for the user comprises identifying at least one personalized recommendation based on the normalized set of scores.

In some implementations, assigning the rank to each of the plurality of items is based on the set of personalized recommendations and the normalized set of scores.

In some implementations, assigning the rank to each of the plurality of items is further based on an estimated or predicted time of play for the item.

Some implementations can include a system comprising a memory with instructions stored thereon and a processing device, coupled to the memory, the processing device configured to access the memory and execute the instructions. The instructions cause the processing device to perform operations including: computing a user-based similarity matrix based at least in part on user data associated with a user of an online gaming platform; obtaining a set of user scores from a first machine learning model and the user-based similarity matrix, wherein the set of user scores indicates a likelihood of user engagement with a plurality of items; computing a game-based similarity matrix based at least in part on game data associated with a game played by the user; obtaining a set of game scores from a second machine learning model and the game-based similarity matrix, wherein the set of game scores indicates a likelihood of user engagement with the plurality of items; combining the set of user scores and the set of game scores to generate a normalized set of scores; identifying a set of personalized recommendations for the user for each item of the plurality of items associated with a subset of the normalized set of scores; assigning a rank to each of the plurality of items based on the set of personalized recommendations; generating a list of items, wherein items in the list of items are ordered based on respective ranks; and providing a user interface to the user that includes the list of items.

Various implementations and examples of the system are described. For example, in some implementations, computing a user-based similarity matrix comprises utilizing a distance function to identify a neighborhood of users similar to the user.

In some implementations, the first machine learning model is trained to compute the set of user scores based on the user-based similarity matrix and the second machine learning model is trained to compute the set of game scores based on the game-based similarity matrix.

In some implementations, computing the game-based similarity matrix comprises utilizing a distance function to identify a neighborhood of games similar to at least one target game.

In some implementations, combining the set of user scores and the set of game scores comprises: normalizing the set of user scores to create normalized user scores; normalizing the set of game scores to create normalized game scores; adding normalized user scores to normalized game scores that overlap; and, combining non-added normalized user scores, non-added normalized game scores, and the added scores to create the normalized set of scores.

In some implementations, identifying the set of personalized recommendations for the user comprises identifying at least one personalized recommendation based on the normalized set of scores.

In some implementations, assigning the rank to each of the plurality of items is based on the set of personalized recommendations and the normalized set of scores.

In some implementations, assigning the rank to each of the plurality of items is further based on an estimated or predicted time of play for the item.

Some implementations can include a non-transitory computer-readable medium with instructions stored thereon that, responsive to execution by a processing device, causes the processing device to perform operations. The operations can include: computing a user-based similarity matrix based at least in part on user data associated with a user of an online gaming platform; obtaining a set of user scores from a first machine learning model and the user-based similarity matrix, wherein the set of user scores indicates a likelihood of user engagement with a plurality of items; computing a game-based similarity matrix based at least in part on game data associated with a game played by the user; obtaining a set of game scores from a second machine learning model and the game-based similarity matrix, wherein the set of game scores indicates a likelihood of user engagement with the plurality of items; combining the set of user scores and the set of game scores to generate a normalized set of scores; identifying a set of personalized recommendations for the user for each item of the plurality of items associated with a subset of the normalized set of scores; assigning a rank to each of the plurality of items based on the set of personalized recommendations; generating a list of items, wherein items in the list of items are ordered based on respective ranks; and providing a user interface to the user that includes the list of items.

Various implementations and examples of the non-transitory computer-readable medium are described. For example, in some implementations, computing a user-based similarity matrix comprises utilizing a distance function to identify a neighborhood of users similar to the user.

In some implementations, the first machine learning model is trained to compute the set of user scores based on the user-based similarity matrix and the second machine learning model is trained to compute the set of game scores based on the game-based similarity matrix.

In some implementations, combining the set of user scores and the set of game scores comprises: normalizing the set of user scores to create normalized user scores; normalizing the set of game scores to create normalized game scores; adding normalized user scores to normalized game scores that overlap; and combining non-added normalized user scores, non-added normalized game scores, and the added scores to create the normalized set of scores.

### BRIEF DESCRIPTION OF THE DRAWINGS

FIG. 1 is a diagram of an example system architecture, in accordance with some implementations.

FIG. 2 is a schematic that illustrates a dataset for personalized recommendations, in accordance with some implementations.

FIG. 3 is a schematic of an example system data flow for personalized recommendations, in accordance with some implementations.

FIG. 4 is a flowchart of an example method to generate a similarity matrix for game-based personalized recommendations, in accordance with some implementations.

FIG. 5 is a flowchart of an example method to generate a similarity matrix for user-based personalized recommendations, in accordance with some implementations.

FIG. 6 is a flow chart of an example method for generating personalized recommendations of game items, in accordance with some implementations.

FIG. 7 is a block diagram illustrating an example computing device which may be used to implement one or more features described herein, in accordance with some implementations.

### DETAILED DESCRIPTION

One or more implementations described herein relate to generation and display of personalized recommendations, for example, in a user interface or search results. The personalized recommendations can include ranking individual items in a list of items based on user data representing a similarity to other users, game data representing a similarity to other games, and/or other factors.

Online gaming platforms (also referred to as “user-generated content platforms” or “user-generated content systems”) offer a variety of ways for users to interact with one another. For example, users of an online gaming platform may create games or other content or resources (e.g., characters, graphics, items for game play within a virtual world, etc.) within the gaming platform.

Users of an online gaming platform may work together towards a common goal in a game or in game creation, share various virtual gaming items, send electronic messages to one another, and so forth. Users of an online gaming platform may play games, e.g., including characters (avatars) or other game objects and mechanisms. An online gaming platform may also allow users of the platform to communicate with each other. For example, users of the online gaming platform may communicate with each other using voice messages (e.g., via voice chat), text messaging, video messaging, or a combination of the above. Some online gaming platforms can provide a virtual three-dimensional environment in which users can play an online game.

In order to help enhance the entertainment value of an online gaming platform, the platform can provide a user interface and/or search engine for recommended games, game content, or other game related resources, where users of the online gaming platform may view and search for game-related content or such other content using the search engine. Since games and game resources may be created, changed, and added to available game data at high rates by various users (including game creators/developers and/or game players), personalized recommendations and a search engine can provide improved discoverability of available games and resources.

For example, a user can login to the platform and be presented with recommended games, items, or other game-related content. In this instance, the search engine searches a set of game data and provides as outputs a list of recommended items and/or game-related resources that were determined by the search engine to be related to the user, ranked by defaults considered by a search algorithm. The defaults may be representative of item features for items available on the platform, optionally with weights assigned to the features determined based on preferences of the users of the platform. For example, the defaults may be based on trends for a large subset of the users or a majority of the users of the platform. Accordingly, recommendations may be ranked based on these trends such that items can be selected by a user to view/purchase an item, initiate and enter the associated game, to communicate with an associated user, or perform some other action related to the selected search result.

However, in some situations, recommendations provided by such search engines may not be satisfactory for a user. For example, the search engine may provide a large number of results, potentially causing confusion and frustration to users who are expecting a targeted set of recommendations relating to their interests or activity. In some online gaming platforms, users have the ability to create a large variety of games, game types, resources etc., thus causing a large number of potential matches to queries and large numbers of recommendations ranked based on the large corpus of user data. While a total number of recommendations may be trimmed or limited to provide only a small number of recommendations thereby reducing the likelihood a user is provided with too many recommendations, the limiting of recommendations may cause instances where more meaningful recommendations are obfuscated entirely.

Furthermore, considering the ephemeral nature of personal interest in a game, rapid changes in gaming patterns, variety of items available, and other factors, personalized recommendations may be difficult to generate based on such variability. While some search engines may improve visibility of some items based on an overarching set of preferences, individual preferences may be partially or entirely ignored.

In addition, an online gaming platform may have a large number of users, e.g., millions of users, whose habits change regularly, periodically, or randomly. Thus, even if overarching user preferences are useful in providing a game developer insight into popular game resources and items, such overarching preferences may be unrelated to a particular user causing a user to ignore portions of a user interface entirely as wasteful recommendations. These interactions may detract from enjoyable gameplay or otherwise reduce user engagement with the platform.

Implementations described herein provide personalized recommendations that are relevant to a user through automatic analysis of a neighborhood of games and a neighborhood of users. For example, user profile data and user behavioral parameters may be used to group similar users into one or more neighborhoods. Furthermore, game data may be used to group similar games into one or more neighborhoods.

A game-based machine learning model based on scoring a similarity between games and a user-based machine learning model based on scoring a similarity between users (and therefore games being played by the users) may be used to create a set of scores representative of items available on the gaming platform. Through normalizing and combining the set of scores, a ranked list of recommendations may be generated that is more closely related to a particular user. Furthermore, as user interactions change both: between a user and games, and between a user and other users; the neighborhoods associated with users and the neighborhoods associated with games may each be reorganized, thereby improving the likelihood that recommendations remain relevant to a particular user despite changing preferences, behaviors, and interactions.

User neighborhoods and game neighborhoods may be dynamically generated (e.g., by reanalyzing the set of users of the platform and generating new similarity scores) periodically based on a variety of factors, including engaging in different games, gaming styles, lengths of gaming sessions, times of gaming sessions, locale/region of users, ages of users, gender, language, and other factors. Thus, corresponding machine learning models may be used to generate new recommendations such that users are provided recommendations that are likely closer to the preferences of the users.

By providing relevant and meaningful recommendations, disclosed features provide technical advantages including reduction of searches of game data as well as reduction in time spent ignoring user interface portions not of interest to users, thus providing a reduction of use of computational resources (e.g., computer memory, processor, networking traffic, of a server etc.) used to generate and present search results and user interfaces to user devices. For example, when a user finds recommendations of useful game items or interesting games as a result of their initial login or within an initial search (which is made more likely by the use of game-based and user-based neighborhoods), extra search computations to retrieve items are eliminated, thus saving computational resources in generating search results, transmitting search results to user devices, and the computational resources of the user device to display the search results.

Further, the described features use sparse matrices to store data related to user and game similarity scores for neighborhoods of users and games. Thus, storage resources that would otherwise be necessary to store individual recommendations for every user and every game are avoided.

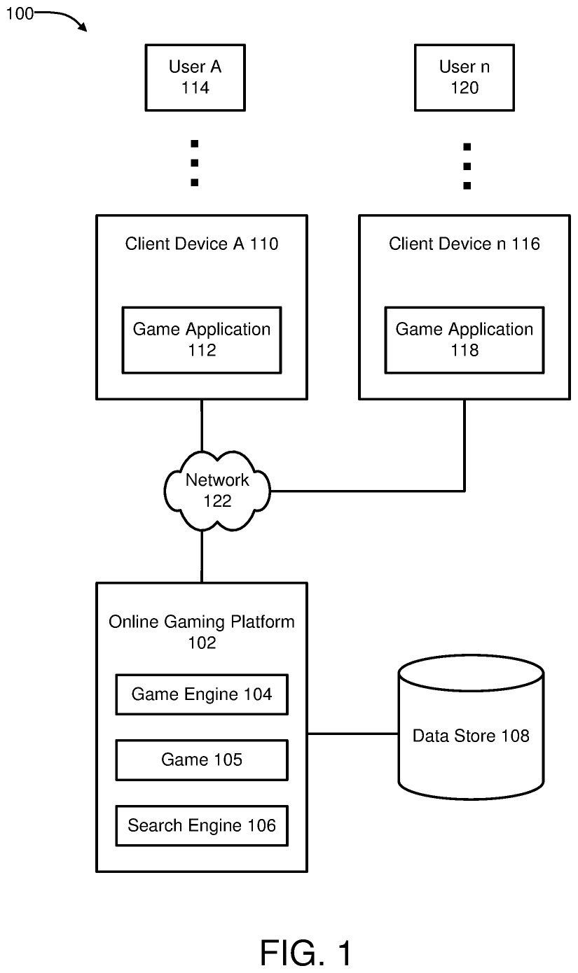

FIG. 1 illustrates an example system architecture 100, in accordance with some implementations of the disclosure. The system architecture 100 (also referred to as “system” herein) includes an online gaming platform 102, a first client device 110, a second client device 116 (generally referred to as “client devices 110/116” herein), and a network 122. The online gaming platform 102 can include, among other things, a game engine 104, one or more games 105, a search engine 106, and a data store 108. The client device 110 can include a game application 112. The client device 116 can include a game application 118. Users 114 and 120 can use client devices 110 and 116, respectively, to interact with the online gaming platform 102.

System architecture 100 is provided for illustration. In some implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online gaming platform 102 can include a server having one or more computing devices (e.g., a cloud computing system, a rackmount server, a server computer, cluster of physical servers, virtual server, etc.). In some implementations, a server may be included in the online gaming platform 102, be an independent system, or be part of another system or platform.

In some implementations, the online gaming platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online gaming platform 102 and to provide a user with access to online gaming platform 102. The online gaming platform 102 may also include a website (e.g., one or more webpages) or application back-end software that may be used to provide a user with access to content provided by online gaming platform 102. For example, users may access online gaming platform 102 using the game application 112/118 on client devices 110/116, respectively.

In some implementations, online gaming platform 102 may include a type of social network providing connections between users or a type of user-generated content system that allows users (e.g., end-users or consumers) to communicate with other users via the online gaming platform 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online gaming platform 102 may be a virtual gaming platform. For example, the gaming platform may provide single-player or multiplayer games to a community of users that may access or interact with games (e.g., user generated games or other games) using client devices 110/116 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may search for games and game items, and participate in gameplay with other users in one or more games. In some implementations, a game may be played in real-time with other users of the game.

In some implementations, other collaboration platforms can be used with search and presentation features described herein instead of or in addition to online gaming platform 102. For example, a social networking platform, purchasing platform, messaging platform, creation platform, etc. can be used.

In some implementations, gameplay may refer to interaction of one or more players using client devices (e.g., 110 and/or 116) within a game (e.g., 105) or the presentation of the interaction on a display or other output device of a client device 110 or 116.

One or more games 105 are provided by the online gaming platform. In some implementations, a game 105 can include an electronic file that can be executed or loaded using software, firmware or hardware configured to present the game content (e.g., digital media item) to an entity. In some implementations, a game application 112/118 may be executed and a game 105 rendered in connection with a game engine 104. In some implementations, a game 105 may have a common set of rules or common goal, and the environments of a game 105 share the common set of rules or common goal. In some implementations, different games may have different rules or goals from one another.

In some implementations, games may have one or more environments (also referred to as “gaming environments” or “virtual environments” herein) where multiple environments may be linked. An example of an environment may be a three-dimensional (3D) environment. The one or more environments of a game 105 may be collectively referred to a “world” or “gaming world” or “virtual world” or “universe” herein. An example of a world may be a 3D world of a game 105. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online gaming platform 102 can host one or more games 105 and can permit users to interact with the games 105 (e.g., search for games, game-related content, or other content) using a game application 112/118 of client devices 110/116. Users (e.g., 114 and/or 120) of the online gaming platform 102 may play, create, interact with, or build games 105, search for games 105, communicate with other users, create and build objects (e.g., also referred to as “item(s)” or “game objects” or “virtual game item(s)” herein) of games 105, and/or search for objects. For example, in generating user-generated virtual items, users may create characters, decoration for the characters, one or more virtual environments for an interactive game, or build structures used in a game 105, among others.

In some implementations, users may buy, sell, or trade game virtual game objects, such as in-platform currency (e.g., virtual currency), with other users of the online gaming platform 102. In some implementations, online gaming platform 102 may transmit game content to game applications (e.g., 112). In some implementations, game content (also referred to as “content” herein) may refer to any data or software instructions (e.g., game objects, game, user information, video, images, commands, media item, etc.) associated with online gaming platform 102 or game applications.

In some implementations, game objects (e.g., also referred to as “item(s)” or “objects” or “virtual game item(s)” herein) may refer to objects that are used, created, shared or otherwise depicted in game applications 105 of the online gaming platform 102 or game applications 112 or 118 of the client devices 110/116. For example, game objects may include a part, model, character, tools, weapons, clothing, buildings, vehicles, currency, flora, fauna, components of the aforementioned (e.g., windows of a building), and so forth.

It may be noted that the online gaming platform 102 hosting games 105, is provided for purposes of illustration, rather than limitation. In some implementations, online gaming platform 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a game 105 may be associated with a particular user or a particular group of users (e.g., a private game), or made widely available to users of the online gaming platform 102 (e.g., a public game). In some implementations, where online gaming platform 102 associates one or more games 105 with a specific user or group of users, online gaming platform 102 may associate the specific user(s) with a game 105 using user account information (e.g., a user account identifier such as username and password).

In some implementations, online gaming platform 102 or client devices 110/116 may include a game engine 104 or game application 112/118. The game engine 104 can include a game application similar to game application 112/118. In some implementations, game engine 104 may be used for the development or execution of games 105. For example, game engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the game engine 104 may generate commands that help compute and render the game (e.g., rendering commands, collision commands, physics commands, etc.). In some implementations, game applications 112/118 of client devices 110/116, respectively, may work independently, in collaboration with game engine 104 of online gaming platform 102, or a combination of both.

In some implementations, both the online gaming platform 102 and client devices 110/116 execute a game engine (104, 112, and 118, respectively). The online gaming platform 102 using game engine 104 may perform some or all the game engine functions (e.g., generate physics commands, rendering commands, etc.), or offload some or all the game engine functions to game engine 104 of client device 110. In some implementations, each game 105 may have a different ratio between the game engine functions that are performed on the online gaming platform 102 and the game engine functions that are performed on the client devices 110 and 116.

For example, the game engine 104 of the online gaming platform 102 may be used to generate physics commands in cases where there is a collision between at least two game objects, while the additional game engine functionality (e.g., generate rendering commands) may be offloaded to the client device 110. In some implementations, the ratio of game engine functions performed on the online gaming platform 102 and client device 110 may be changed (e.g., dynamically) based on gameplay conditions. For example, if the number of users participating in gameplay of a game 105 exceeds a threshold number, the online gaming platform 102 may perform one or more game engine functions that were previously performed by the client devices 110 or 116.

For example, users may be playing a game 105 on client devices 110 and 116, and may send control instructions (e.g., user inputs, such as right, left, up, down, user election, or character position and velocity information, etc.) to the online gaming platform 102. Subsequent to receiving control instructions from the client devices 110 and 116, the online gaming platform 102 may send gameplay instructions (e.g., position and velocity information of the characters participating in the group gameplay or commands, such as rendering commands, collision commands, etc.) to the client devices 110 and 116 based on control instructions. For instance, the online gaming platform 102 may perform one or more logical operations (e.g., using game engine 104) on the control instructions to generate gameplay instruction for the client devices 110 and 116. In other instances, online gaming platform 102 may pass one or more of the control instructions from one client device 110 to other client devices (e.g., 116) participating in the game 105. The client devices 110 and 116 may use the gameplay instructions and render the gameplay for presentation on the displays of client devices 110 and 116.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online gaming platform 102. In other implementations, the control instructions may be sent from a client device 110 to another client device (e.g., 116), where the other client device generates gameplay instructions using the local game engine 104. The control instructions may include instructions to play a voice communication message or other sounds from another user on an audio device (e.g., speakers, headphones, etc.).

In some implementations, gameplay instructions may refer to instructions that allow a client device 110 (or 116) to render gameplay of a game, such as a multiplayer game. The gameplay instructions may include one or more of user input (e.g., control instructions), character position and velocity information, or commands (e.g., physics commands, rendering commands, collision commands, etc.).

In some implementations, characters (or game objects generally) are constructed from components, one or more of which may be selected by the user, that automatically join together to aid the user in editing. One or more characters (also referred to as an “avatar” or “model” herein) may be associated with a user where the user may control the character to facilitate a user's interaction with the game 105. In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character game object (e.g., body parts, etc.) but the user may control the character (without the character game object) to facilitate the user's interaction with the game (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online gaming platform 102. In some implementations, creating, modifying, or customizing characters, other game objects, games 105, or game environments may be performed by a user using a user interface (e.g., developer interface) and with or without scripting (or with or without an application programming interface (API)). It may be noted that for purposes of illustration, rather than limitation, characters are described as having a humanoid form. In may further be noted that characters may have any form such as a vehicle, animal, inanimate object, or other creative form.

In some implementations, the online gaming platform 102 may store characters created by users in the data store 108. In some implementations, the online gaming platform 102 maintains a character catalog and game catalog that may be presented to users via the search engine 106, game engine 104, game 105, and/or client device 110/116. In some implementations, the game catalog includes images of games stored on the online gaming platform 102. In addition, a user may select a character (e.g., a character created by the user or other user) from the character catalog to participate in the chosen game. The character catalog includes images of characters stored on the online gaming platform 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online gaming platform 102.

In some implementations, the client device(s) 110 or 116 may each include computing devices such as personal computers (PCs), mobile devices (e.g., laptops, mobile phones, smart phones, tablet computers, or netbook computers), network-connected televisions, gaming consoles, etc. In some implementations, a client device 110 or 116 may also be referred to as a “user device.” In some implementations, one or more client devices 110 or 116 may connect to the online gaming platform 102 at any given moment. It may be noted that the number of client devices 110 or 116 is provided as illustration, rather than limitation. In some implementations, any number of client devices 110 or 116 may be used.

In some implementations, each client device 110 or 116 may include an instance of the game application 112 or 118, respectively. In one implementation, the game application 112 or 118 may permit users to use and interact with online gaming platform 102, such as search for a game or other content, control a virtual character in a virtual game hosted by online gaming platform 102, or view or upload content, such as games 105, images, video items, web pages, documents, and so forth. In one example, the game application may be a web application (e.g., an application that operates in conjunction with a web browser) that can access, retrieve, present, or navigate content (e.g., virtual character in a virtual environment, etc.) served by a web server. In another example, the game application may be a native application (e.g., a mobile application, app, or a gaming program) that is installed and executes local to client device 110 or 116 and allows users to interact with online gaming platform 102. The game application may render, display, or present the content (e.g., a web page, a user interface, a media viewer) to a user. In an implementation, the game application may also include an embedded media player (e.g., a Flash® player) that is embedded in a web page.

According to aspects of the disclosure, the game application 112/118 may be an online gaming platform application for users to build, create, edit, upload content to the online gaming platform 102 as well as interact with online gaming platform 102 (e.g., play games 105 hosted by online gaming platform 102). As such, the game application 112/118 may be provided to the client device 110 or 116 by the online gaming platform 102. In another example, the game application 112/118 may be an application that is downloaded from a server.

In some implementations, a user may login to online gaming platform 102 via the game application. The user may access a user account by providing user account information (e.g., username and password) where the user account is associated with one or more characters available to participate in one or more games 105 of online gaming platform 102.

In general, functions described as being performed by the online gaming platform 102 can also be performed by the client device(s) 110 or 116, or a server, in other implementations if appropriate. In addition, the functionality attributed to a particular component can be performed by different or multiple components operating together. The online gaming platform 102 can also be accessed as a service provided to other systems or devices through appropriate application programming interfaces (APIs), and thus is not limited to use in websites.

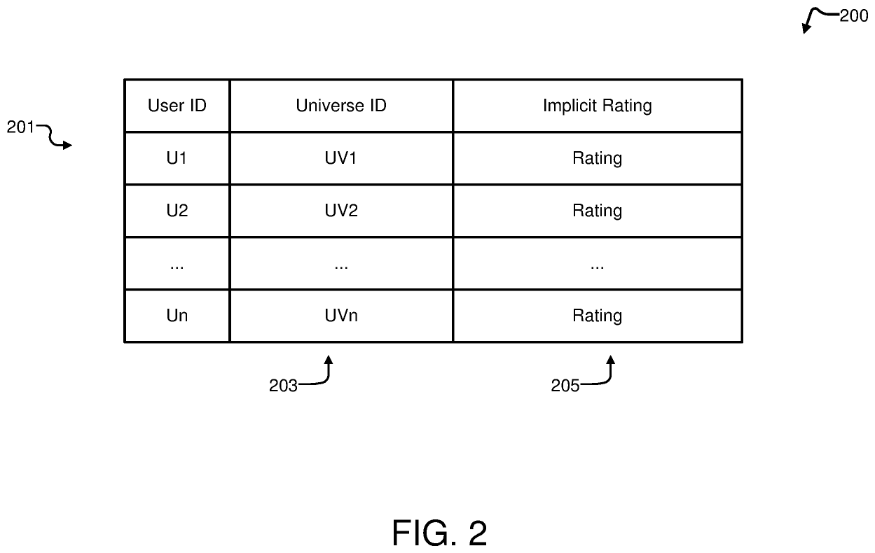

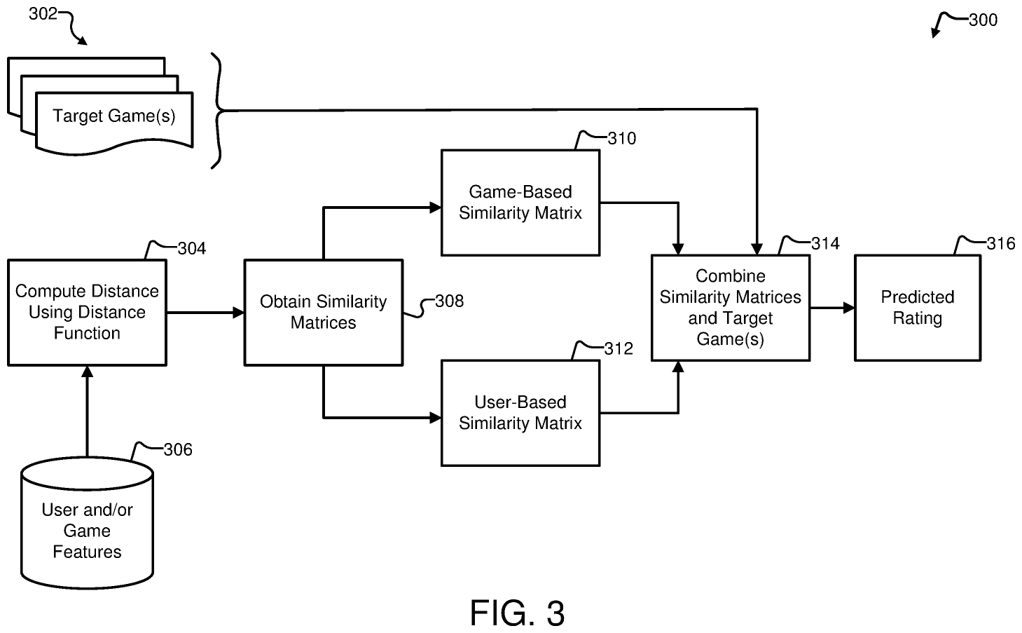

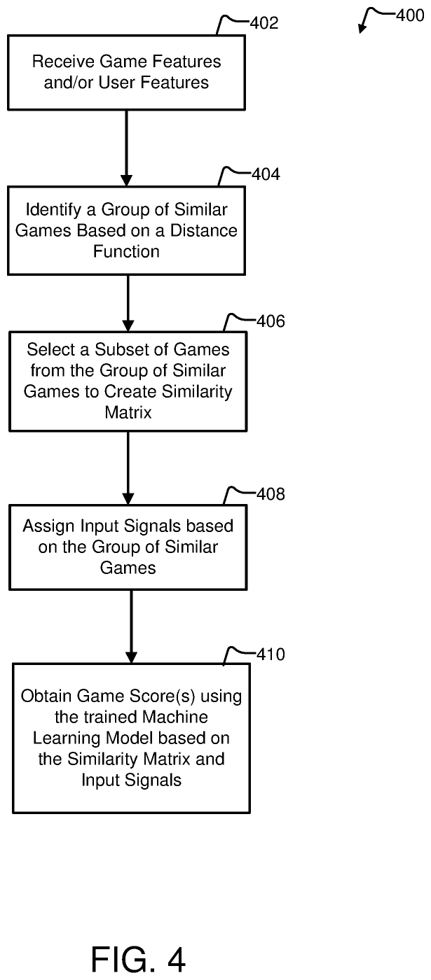

In some implementations, online gaming platform 102 may include a search engine 106. In some implementations, the search engine 106 may be a system, application, or module that permits the online gaming platform 102 to provide search functionality to users, where the search functionality permits the users to search for games, game-related content, items, listing of items, or other content within the online gaming platform 102. In some implementations, the search engine 106 may perform one or more of the operations described below in connection with the flowcharts shown in FIGS. 4, 5, and 6, utilizing the features illustrated in FIGS. 2 and 3. It is further noted, that although described as a “search” engine, the search engine 106 may provide results including game-related and personalized recommendations to users without submission of a search query, for example, through a user interface appropriate to display proposed or recommended game-related items.

FIG. 2 is a schematic that illustrates a dataset 200 for personalized recommendations, in accordance with some implementations.

The dataset 200 may include data operative to generate predictions on a periodic, regular, or asynchronous basis. The dataset 200 may include data including user identification data (User ID) 201, universe identification data (Universe ID) 203, and/or an implicit rating data 205. Generally, the user ID 201 may include any data related to identifying a user of the online gaming platform 102. For example, an identification number, serial number, login name, and other suitable data may be used to identify a user.

The universe ID 203 may include any data related to identifying a game accessible through the online platform 102. For example, a unique identifier such as a serial number, game number, game revision number, and/or other suitable data may be at least partially used to identify a particular game, game environment, iteration of a game, and other similar attributes as the universe ID.

The implicit rating 205 may include data related to inferring user preferences related to a particular game or universe ID (e.g., a particular universe ID—User ID pair or a user-game pair), as well as user preferences related to other games. The implicit rating 205 may be unique to user-game pairs and include the inferred preferences. The inferred preferences may be determined through analysis of attributes associated with user interaction and game play. For example, attributes can include a total time a user has played a game, a number of times a user has played a game, a number of times a user has searched for a game, a number of search queries including the game within returned results, and other suitable attributes.

Furthermore, user features and game features may be combined into a scalar representation to create the implicit rating 205. For example, features such as percentiles of users ranked by playtime across all users for each game and percentiles of games ranked by playtime across all games for a particular user may be suitable features for generating the implicit rating 205. The percentiles of users may include a relative rank of the user among all users who have engaged or played a particular game. Similarly, the percentiles of games may include a relative rank of a game among all games which have been played by a particular user. Thus, each user-game pair 201-203, allows creation of the particular implicit rating 205, without further input by the user.

Suitable percentiles may be based on playtime, as outlined below, but may additionally or alternatively be based on any suitable metric. Examples of other suitable metrics may include, a) rank based on the total play time of a user among all users of a game; b) rank based on the median play time of a user among all users of a game; c) rank based on the total play time of a game among all games for a user; and d) rank based on the median play time of a game among all games for a user.

Linear estimation may be used to assign weights to any of the above features. For example, weights may be increased, decreased, or otherwise assigned using a best linear unbiased estimator (BLUE), or another estimation. The weights may be used to ensure proper combination of features in the dataset 200 to create the implicit ratings 205. Upon generation of the dataset 200, a combination of machine learning models may be trained to generate scores of the likelihood a particular user would engage with, and/or positively rate, a particular game, as described with reference to FIG. 3.

FIG. 3 is a schematic 300 of an example system data flow for personalized recommendations, in accordance with some implementations.

As illustrated, one or more target games 302 (such as game 105) may be evaluated for presentation to a user as a personalized recommendation. Furthermore, target game items (in-game items, avatars, tools, etc.) may also be evaluated periodically for presentation to a user as a personalized recommendation.

Initially, a distance may be computed using a distance function 304, based on user and/or game features 306, as described above. For example, a distance function such as a cosine similarity function, cross product similarity function, common kernel functions, or other distance functions may be appropriate.

Upon computing of the distance, similarity matrices may be obtained (308). The similarity matrices can include one or both of a game-based similarity matrix 310 and a user-based similarity matrix 312. The game-based similarity matrix 310 is a sparse matrix computed based upon the distance (neighborhood) between a game with other games within a corpus of games available via the online gaming platform 102. The game-based similarity matrix 310 may also be termed a game-to-game similarity matrix. The user-based similarity matrix 312 is a sparse matrix computed based upon the distance (neighborhood) between a user with other users within a corpus of users of the online gaming platform 102. The user-based similarity matrix 312 may also be termed a user-to-user similarity matrix.

As described above, the matrices 310 and 312 are generally represented not in dense form but in sparse form to save memory. For the game-based similarity matrix 310, the size of matrix is generally a number of games X 50, assuming 50 similar games per game. More or fewer games may also be applicable. For the user-based similarity matrix, the size of matrix is generally a number of users X 10, assuming 10 similar users per user based on thresholding of the similarity scores. More or fewer users may also be applicable.

Using the similarity matrices 310 and 312, a combination of ratings 314 for each of target game(s) 302 is computed based upon each matrix. With regard to the game-based similarity matrix 310, ratings of games within the matrix 310 that are similar to each target game of target games 302 are combined to generate a combined prediction of a rating. This prediction of a rating is game-based in this instance, and is a prediction of what one or more of the target games 302 would be rated by a user. The prediction may also be considered a weighted average of ratings by similarity scores.

With regard to the user-based similarity matrix, ratings generated from other users who have played one or more of the target games 302 within the matrix 312 that are similar to a user (e.g., the user being the target of prediction for receipt of recommendations) are combined to generate a prediction of what one or more of the target games 302 are likely to be rated by the user. The prediction may also be considered a weighted average of ratings by similarity scores.

The matrices and target game(s) are combined to form the predicted rating 316. The predicted rating 316 is therefore a combination of predictions based on a neighborhood of games as well as a neighborhood of users. In this manner, drawbacks associated with predictions based on only users, only games, or an overarching rating based on all users, is reduced or eliminated. Furthermore, a more accurate prediction can be made as to a user's perceived rating for games that are recommended by both the user-based and game-based algorithm. Aspects include predictions by both game-based and user-based algorithms to increase the diversity for game recommendations.

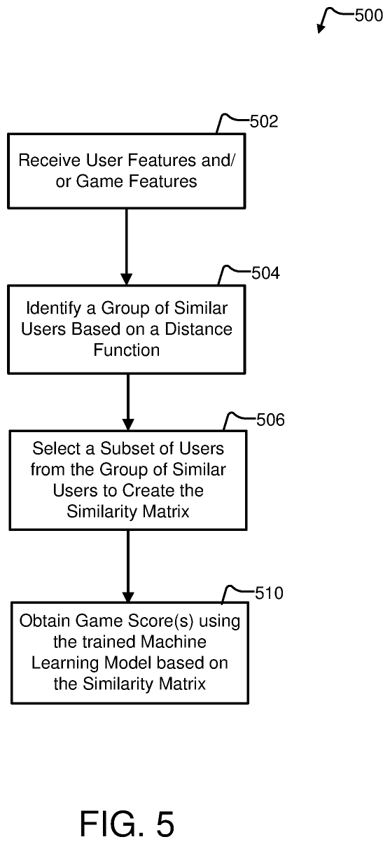

Using the predicted ratings 316 for the target games 302, a ranked list of recommendations can be formed, processed, and presented to a user through a user interface and/or search engine. Hereinafter, a more detailed discussion of the computation and creation of the similarity matrices 310, 312 is provided with reference to FIGS. 4 and 5.

FIG. 4 is a flowchart of an example method 400 to generate a similarity matrix for game-based personalized recommendations, in accordance with some implementations. In some implementations, method 400 can be implemented, for example, on a server system, e.g., online gaming platform 102 as shown in FIG. 1. In some implementations, some or all of the method 400 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 400. Method 400 may begin at block 402.

Blocks 402-406 illustrate computing a game-based similarity matrix. In block 402, game data for a plurality of games and/or user-game pairs is obtained, e.g., at a server. For example, game data features including percentiles of users ranked by playtime across all users for each game and percentiles of games ranked by playtime across all games for a user may be suitable features. The percentiles of users may include a relative rank of a user among all users who have engaged or played a particular game. Similarly, the percentiles of games may include a relative rank of a game among all games which have been played by a particular user.

Suitable percentiles may be based on playtime, as outlined below, but may also be based on any suitable metric. Suitable percentiles may include a) rank based on the total play time of a user among all users of a game; b) rank based on a median play time of a user among all users of a game; c) rank based on total play time of a game among all games for a user; and d) rank based on median play time of a game among all games for a user. Block 402 may be followed by block 404.

In block 404, a group of games similar to one or more target games 302 is identified based on a distance function (e.g., 304). For identifying the similar games, a group of users associated with the group of games is divided into subgroups to aid in speeding computation. Suitable groupings may include any number of users capable of being processed effectively, or a single grouping. The subgroups are processed with a similarity function to determine that the user-game pairs are within a threshold distance indicative of a neighborhood. Block 404 is followed by block 406.

In block 406, a subset of games is selected from the group of similar games to create the final, sparse similarity matrix. For example, any identifiable “clone” games may be discarded through filtering criteria or other manners. Similarly, other unwanted user-game pairs may be removed. Finally, any game data related to users that have not played the game may be removed, such that the similarity matrix is sparse, and reduces storage and computation requirements. Accordingly, while a typical matrix may store all possible user-game pairs, this sparse matrix may be significantly smaller in storage size. Block 406 is followed by block 408.

In block 408, input signals based on the group of similar games are assigned. Input signals can vary based on specific implementations, but may include any data relevant to determining a predicted rating for a target game 302. In one example, the input signals may be termed input quality signals. The input signals may include weights assigned to a particular game based on how much it has been played by all users, how much it has been played by a particular or target user, or a product of both attributes. Accordingly, in one example, a weight may include a value of how much it has been played by all users multiplied with how much it has been played by a particular user. Block 408 is followed by block 410.

In block 410, the similarity matrix and input signals are provided to a game-based machine learning model. The game-based machine learning model may be a trained machine learning model in some examples. The training of the game-based machine learning model may include supervised or unsupervised learning. An example of a machine learning model that can be used is matrix factorization for computing a confidence score for whether a game could be liked by a user. More advanced models, such as deep learning, use more user and game related signals, and may also be applicable.

In block 410, game scores may be generated by the game-based machine learning model. For example, the game-based machine learning model may determine a prediction of recommendations among games through intelligent consideration of a number of games contained in the similarity matrix. For n games played by a user, a list of ratings (r₁, r₂, . . . , rₙ), a list of similarity scores (s₁, s₂, . . . , sₙ), and the input signals (q₁, q₂, . . . , qₙ) may be established based on the data and input signals described above. The predicted score Sₜ of a target game t being liked by a user is established through the machine learning model based on Function 1, presented below:

Function 1:

$${S}_{t} = \frac{{q}_{1} * {s}_{1} * {r}_{1} + {q}_{2} * {s}_{2} * {r}_{2} + … + {q}_{n} * {s}_{n} * {r}_{n}}{{q}_{1} * {s}_{1} + {q}_{2} * {s}_{2} + … + {q}_{n} * {s}_{n}}$$

The generated game scores/predictions may then be further processed and/or combined as described herein with reference to FIGS. 3, 5, and 6, for viewing by the user. Blocks 402-410 can be performed (or repeated) in a different order than described above and/or one or more blocks can be omitted. Hereinafter, a more detailed description of computing similarity matrices based on user data is presented with reference to FIG. 5.

FIG. 5 is a flowchart of an example method 500 to generate a similarity matrix for user-based personalized recommendations, in accordance with some implementations. In some implementations, method 500 can be implemented, for example, on a server system, e.g., online gaming platform 102 as shown in FIG. 1. In some implementations, some or all of the method 500 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 500. Method 500 may begin at block 502.

Blocks 502-506 illustrate computing a user-based similarity matrix. In block 502, user data for a plurality of users is obtained, e.g., at a server. For example, features including percentiles of users ranked by playtime across all users for each game and percentiles of games ranked by playtime across all games for a user may be suitable features. The percentiles of users may include a relative rank of a user among all users who have engaged or played a particular game. Similarly, the percentiles of games may include a relative rank of a game among all games which have been played by a particular user.

Suitable percentiles are described above and may be based on playtime, but may also be based on any suitable metric. Suitable percentiles may include a) rank based on the total play time of a user among all users of a game; b) rank based on the median play time of a user among all users of a game; c) rank based on the total play time of a game among all games for a user; and d) rank based on the median play time of a game among all games for a user. Block 502 may be followed by block 504.

In block 504, a group of users similar to a particular user is identified based on a distance function. For identifying the similar users, a group of users associated with the group of games is indexed to aid in speeding computation. The indexing may be based on interactions between users. For example, if two users have interacted and have played the same games, an index is built based on the game. In this example, a component for cross-product between all other pairs lacking this interaction is avoided in subsequent operations. The indexed games are processed with a similarity function to determine that the user-game pairs are within a threshold distance indicative of a neighborhood. Block 504 is followed by block 506.

In block 506, a subset of users is selected from the group of similar users to create a final, sparse similarity matrix. For example, if a user has multiple profiles, a single profile may be used as a single similarity matrix. In other examples, multiple profiles may be treated in different matrices through repetition of the method 500. Similarly, other unwanted user-game pairs may be removed through filtering, including cloned games or copies. Finally, any user data may be normalized such that the similarity function used (e.g., cosine similarity) degenerates to cross product only, and the similarity matrix is sparse, reducing storage and computation requirements. For example, only the nearest users or games are selected for prediction. Accordingly, while a typical matrix may store all possible user-game pairs, this sparse matrix may be significantly smaller in storage size.

Other restrictions based on computational requirements may be taken into consideration. For example, an upper limit for user-game pairs may be utilized, in some implementations, to reduce computational complexity, and to reduce computing resource use. Similarly, a limit or threshold of similar users may be implemented in the matrix. According to one implementation, a threshold number of users M is implemented. The threshold M may be 10 users, 50 users, 100 users, or 500 users, in some implementations. In other implementations, any threshold M may be utilized. Block 506 is followed by block 510.

In block 510, the similarity matrix is provided to a user-based machine learning model. The user-based machine learning model may be a trained machine learning model in some examples. The training of the user-based machine learning model may include supervised or unsupervised learning.

In block 510, user scores may also be generated. For example, the user-based machine learning model may determine a prediction of recommendations among games through intelligent consideration of a number of games contained in the similarity matrix. For a particular user, a number n of neighboring users in the similarity matrix, a list of ratings of neighborhood users (r₁, r₂, . . . , rₙ), and a list of similarity scores (s₁, s₂, . . . , sₙ) may be established based on the data described above. The predicted score St of a target game t being liked by a user is established through the machine learning model based on Function 2, presented below:

Function 2:

$${S}_{t} = \frac{{s}_{1} * {r}_{1} + {s}_{2} * {r}_{2} + … + {s}_{n} * {r}_{n}}{{s}_{1} + {s}_{2} + … + {s}_{n}}$$

The generated scores / predictions may then be further processed and/or combined as described herein with reference to FIGS. 3, 4, and 6, for viewing by the user.

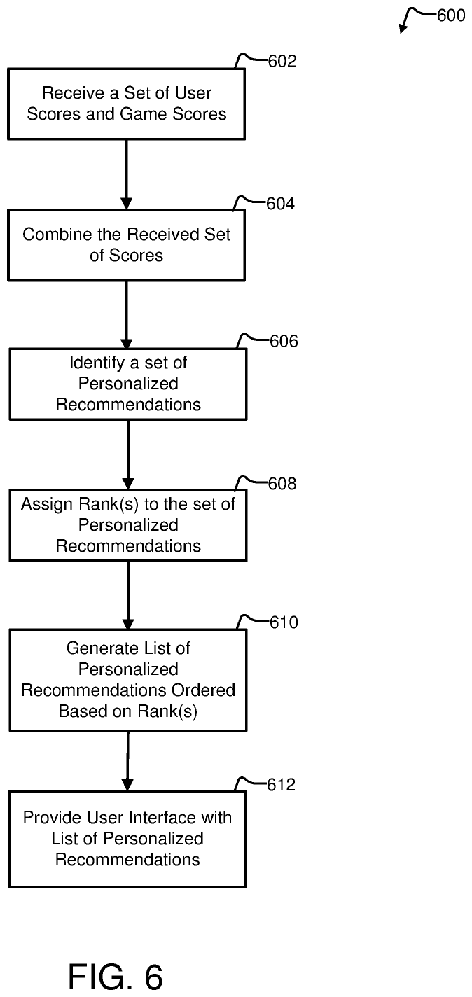

Blocks 502-510 can be performed (or repeated) in a different order than described above and/or one or more blocks can be omitted. Hereinafter, a more detailed description of using computed similarity matrices to generated personalized recommendations is presented with reference to FIG. 6.

FIG. 6 is a flow chart of an example method 600 for generating personalized recommendations of game items, in accordance with some implementations. In some implementations, method 600 can be implemented, for example, on a server system, e.g., online gaming platform 102 as shown in FIG. 1. In some implementations, some or all of the method 600 can be implemented on a system such as one or more client devices 110 and 116 as shown in FIG. 1, and/or on both a server system and one or more client systems. In described examples, the implementing system includes one or more processors or processing circuitry, and one or more storage devices such as a database or other accessible storage. In some implementations, different components of one or more servers and/or clients can perform different blocks or other parts of the method 600. Method 600 may begin at block 602.

In block 602, a set of user scores and game scores may be retrieved from the associated machine learning models described above with reference to FIGS. 4-5. For example, a set of user scores may be obtained from a first machine learning model, wherein the set of user scores indicates a likelihood of user engagement with a plurality of items. The likelihood of user engagement may be a metric or scalar that is normalized for appropriate comparison to, and combination with, the game scores. Block 602 also includes obtaining a set of game scores from a second machine learning model, wherein the set of game scores indicates a likelihood of user engagement with the plurality of items. The likelihood of engagement may be a metric or scalar that is normalized for appropriate comparison to, and combination with, the user scores. Block 602 is followed by block 604.

In block 604, the set of user scores and the set of game scores are combined to generate a normalized set of scores. For example, the set of user scores and the set of game scores may be normalized to values between 0 and 1. Thereafter, if a user score and a game score both exist (e.g., overlap) for a particular target game 302, both scores are added/combined (e.g., 314) to achieve a combined score having a value between 0 and 2. However, if a user score and a game score do not coexist for a particular target game 302, only the existing score is used as the combined score (314), which will ostensibly have a value between 0 and 1. The term “combination” may also be referred to as “blending”. Other combination methodologies and blending functions (e.g., z-score normalization) may also be applicable. Generally, the combination or blending may achieve an improved result of both algorithms, where the game-based collaborative filtering algorithm provides more accurate but less diverse recommendations, and the user-based collaborative filtering algorithm may give less accurate but more diverse and serendipitous recommendations. Thus, an appropriate tradeoff between these two objectives may be used to increase the total play time and/or engagement by users. Block 604 is followed by block 606.

In block 606, a set of personalized recommendations for the user for each item of the plurality of items associated with a subset of the normalized set of scores is identified. Each item (e.g., a target game 302) is aggregated into a set of personalized recommendations. It should be understood that this may include all recommendations, but may not be a final listing of recommendations that is presented to a user. Block 606 is followed by block 608.

In block 608, a rank for each of the plurality of items based on the set of personalized recommendations is generated. The rank may be based solely on the combined scores. In this manner, the ranks may be ordered from greatest to least, with associated scores having values between 0 and 2. Under some circumstances, such as when there is no overlap between user scores and game scores, the values will range between 0 and 1. Other ranking signals may also be implemented to augment (or in alternative to) the normalized combined scores. For example, ranking may be based on expected play time or expected user rating. Furthermore, a multiplicative rank may be generated through combination of the combined score and expected play time. Still further, other ranking signals may be used depending upon any desired implementation. Block 608 is followed by block 610.

In block 610, a list of items is generated, where the items in the list of items are ordered based on respective ranks. Accordingly, a ranked, sorted list of personalized recommendations is formed. This list may be trimmed based on any suitable threshold, including only providing a number of recommendations that fit within a particular user interface, within a particular user interface section, within a list of other search results, or otherwise limited to avoid a large, distracting number of recommendations. According to one implementation, a “Top 100” list of personalized recommended games is provided. Block 610 is followed by block 612.

In block 612, a user interface is provided to the user that includes the list of items. This may include the trimmed listing, including a “Top 100” or other number of personalized recommendations. It should be understood that while the recommendations may be described as being generated through a search query and interspersed within a search result, the same can be varied to include a particular user interface portion, such as a welcome screen, which is prompted through login by a user. Similarly, a list of personalized recommendations may be presented after exiting a game (e.g., “Would you like to try this next?”), manipulating a game item (“Check out these other items!”), searching for a user (“User B also likes these games”), searching for a particular game (“Check out these titles other users liked”), or through any other manner.

Iterations of the methods 400, 500, and 600 may be performed periodically (e.g., every 30 days, every day, etc.) and may be stored and associated with user profile data for fast retrieval under a variety of circumstances (e.g., logging in, logging out, exiting a game, entering a game, etc.). Methods 400, 500, and/or 600 can be performed on a server (e.g., 102) and/or a client device (e.g., 110 or 116). Furthermore, portions of the methods 400, 500, and 600 may be combined and performed in sequence or in parallel, according to any desired implementation.

As described above, the techniques of personalized recommendations can be implemented through filtering of users and games based on a distance function (e.g., a cosine distance function to establish a neighborhood) such that applicable and/or meaningful recommendations are ranked and presented in a manner that increases or improves user engagement in an online gaming platform. The techniques may be customized to improve user engagement in other fields, including any field where a search engine or user interface is used to provide a ranked list of personalized results.

The personalized recommendations may offer a view for different users to explore items of interest to similar users or games played by similar users, thereby improving a user experience. Through separate calculation of both a user-based matrix and a game-based matrix, different types and groups of users may receive recommendations more suitable or less frustrating than in conventional systems.

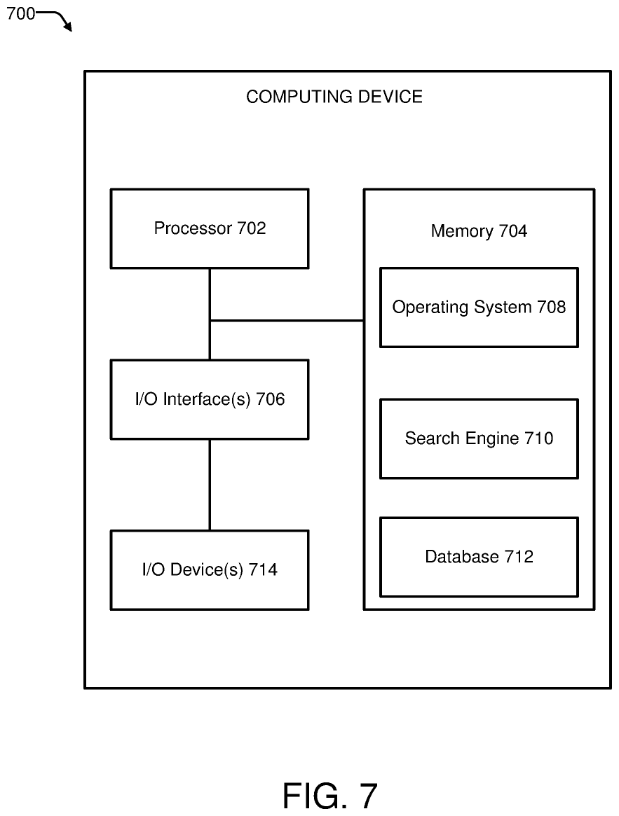

Hereinafter, a more detailed description of various computing devices that may be used to implement different devices illustrated in FIG. 1 is provided with reference to FIG. 7.

FIG. 7 is a block diagram of an example computing device 700 which may be used to implement one or more features described herein, in accordance with some implementations. In one example, device 700 may be used to implement a computer device, (e.g., 102, 110, and/or 116 of FIG. 1), and perform appropriate method implementations described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 700 includes a processor 702, a memory 704, input/output (I/O) interface 706, and audio/video input/output devices 714 (e.g., display screen, touchscreen, display goggles or glasses, audio speakers, microphone, etc.).

Processor 702 can be one or more processors and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, a search engine application 710 and associated data 712. In some implementations, the search engine application 710 can include instructions that enable processor 702 to perform the functions described herein, e.g., some or all of the methods of FIGS. 4, 5, and 6.

For example, memory 704 can include software instructions for a search engine 710 that can provide search with dynamically customized rankings within an online gaming platform (e.g., 102). Any of software in memory 704 can alternatively be stored on any other suitable storage location or computer-readable medium. In addition, memory 704 (and/or other connected storage device(s)) can store instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. For example, network communication devices, storage devices (e.g., memory and/or data store 108), and input/output devices can communicate via interface 706. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 7 shows one block for each of processor 702, memory 704, I/O interface 706, software blocks 708 and 710, and database 712. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While the online gaming platform 102 is described as performing operations as described in some implementations herein, any suitable component or combination of components of online gaming platform 102 or similar system, or any suitable processor or processors associated with such a system, may perform the operations described.

A user device can also implement and/or be used with features described herein. Example user devices can be computer devices including some similar components as the device 700, e.g., processor(s) 702, memory 704, and I/O interface 706. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 714, for example, can be connected to (or included in) the device 700 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., methods 400 and/or 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

In situations in which certain implementations discussed herein may obtain or use user data (e.g., user demographics, user behavioral data on the platform, user search history, items purchased and/or viewed, user's friendships on the platform, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
computing a user-based similarity matrix based at least in part on user data associated with a user of an online gaming platform;
obtaining a set of user scores from a first machine learning model and the user-based similarity matrix, wherein the set of user scores indicates a likelihood of user engagement with a plurality of items;
computing a game-based similarity matrix based at least in part on game data associated with a game played by a user within the user-based similarity matrix;
obtaining a set of game scores from a second machine learning model and the game-based similarity matrix, wherein the set of game scores indicates a likelihood of user engagement with the plurality of items;
combining the set of user scores and the set of game scores to generate a normalized set of scores;
identifying a set of personalized recommendations for the user for each item of the plurality of items associated with a subset of the normalized set of scores;
assigning a rank to each of the plurality of items based on the set of personalized recommendations;
generating a list of items, wherein items in the list of items are ordered based on respective ranks; and
providing a user interface to the user that includes the list of items.

2. The computer-implemented method of claim 1, wherein computing the user-based similarity matrix comprises utilizing a distance function to identify a neighborhood of users similar to the user.

3. The computer-implemented method of claim 1, wherein the first machine learning model is trained to compute the set of user scores based on the user-based similarity matrix and the second machine learning model is trained to compute the set of game scores based on the game-based similarity matrix.

4. The computer-implemented method of claim 1, wherein computing the game-based similarity matrix comprises utilizing a distance function to identify a neighborhood of games similar to at least one target game.

5. The computer-implemented method of claim 1, wherein combining the set of user scores and the set of game scores comprises:
normalizing the set of user scores to create normalized user scores;
normalizing the set of game scores to create normalized game scores;
adding normalized user scores to normalized game scores that overlap; and
combining non-added normalized user scores, non-added normalized game scores, and the added scores to obtain the normalized set of scores.

6. The computer-implemented method of claim 1, wherein identifying the set of personalized recommendations for the user comprises identifying at least one personalized recommendation based on the normalized set of scores.

7. The computer-implemented method of claim 1, wherein assigning the rank to each of the plurality of items is based on the set of personalized recommendations and the normalized set of scores.

8. The computer-implemented method of claim 1, wherein assigning the rank to each of the plurality of items is further based on an estimated or predicted time of play for the item.

9. A system comprising:
a memory with instructions stored thereon; and
a processing device, coupled to the memory, the processing device configured to access the memory and execute the instructions, wherein the instructions cause the processing device to perform operations comprising:
computing a user-based similarity matrix based at least in part on user data associated with a user of an online gaming platform;
obtaining a set of user scores from a first machine learning model and the user-based similarity matrix, wherein the set of user scores indicates a likelihood of user engagement with a plurality of items;
computing a game-based similarity matrix based at least in part on game data associated with a game played by the user;
obtaining a set of game scores from a second machine learning model and the game-based similarity matrix, wherein the set of game scores indicates a likelihood of user engagement with the plurality of items;
combining the set of user scores and the set of game scores to generate a normalized set of scores;
identifying a set of personalized recommendations for the user for each item of the plurality of items associated with a subset of the normalized set of scores;
assigning a rank to each of the plurality of items based on the set of personalized recommendations;
generating a list of items, wherein items in the list of items are ordered based on respective ranks; and
providing a user interface to the user that includes the list of items.

10. The system of claim 9, wherein computing a user-based similarity matrix comprises utilizing a distance function to identify a neighborhood of users similar to the user.

11. The system of claim 9, wherein the first machine learning model is trained to compute the set of user scores based on the user-based similarity matrix and the second machine learning model is trained to compute the set of game scores based on the game-based similarity matrix.

12. The system of claim 9, wherein computing the game-based similarity matrix comprises utilizing a distance function to identify a neighborhood of games similar to at least one target game.

13. The system of claim 9, wherein combining the set of user scores and the set of game scores comprises:
normalizing the set of user scores to create normalized user scores;
normalizing the set of game scores to create normalized game scores;
adding normalized user scores to normalized game scores that overlap; and
combining non-added normalized user scores, non-added normalized game scores, and the added scores to create the normalized set of scores.

14. The system of claim 9, wherein identifying the set of personalized recommendations for the user comprises identifying at least one personalized recommendation based on the normalized set of scores.

15. The system of claim 9, wherein assigning the rank to each of the plurality of items is based on the set of personalized recommendations and the normalized set of scores.

16. The system of claim 9, wherein assigning the rank to each of the plurality of items is further based on an estimated or predicted time of play for the item.

17. A non-transitory computer-readable medium with instructions stored thereon that, responsive to execution by a processing device, cause the processing device to perform operations comprising:
computing a user-based similarity matrix based at least in part on user data associated with a user of an online gaming platform;
obtaining a set of user scores from a first machine learning model and the user-based similarity matrix, wherein the set of user scores indicates a likelihood of user engagement with a plurality of items;
computing a game-based similarity matrix based at least in part on game data associated with a game played by the user;
obtaining a set of game scores from a second machine learning model and the game-based similarity matrix, wherein the set of game scores indicates a likelihood of user engagement with the plurality of items;
combining the set of user scores and the set of game scores to generate a normalized set of scores;
identifying a set of personalized recommendations for the user for each item of the plurality of items associated with a subset of the normalized set of scores;
assigning a rank to each of the plurality of items based on the set of personalized recommendations;
generating a list of items, wherein items in the list of items are ordered based on respective ranks; and
providing a user interface to the user that includes the list of items.

18. The non-transitory computer-readable medium of claim 17, wherein computing a user-based similarity matrix comprises utilizing a distance function to identify a neighborhood of users similar to the user.

19. The non-transitory computer-readable medium of claim 17, wherein the first machine learning model is trained to compute the set of user scores based on the user-based similarity matrix and the second machine learning model is trained to compute the set of game scores based on the game-based similarity matrix.

20. The non-transitory computer-readable medium of claim 17, wherein combining the set of user scores and the set of game scores comprises:
normalizing the set of user scores to create normalized user scores;
normalizing the set of game scores to create normalized game scores;
adding normalized user scores to normalized game scores that overlap; and
combining non-added normalized user scores, non-added normalized game scores, and the added scores to create the normalized set of scores.
